(19) United States
(12) Patent Application Publication
(10) Pub. No.: US 2009/0251899 A1
(43) Pub. Date: Oct. 8, 2009

(54) Flexible Spotlight

(76) Inventor: James E. Borchert, Plano, TX (US)

Correspondence Address: WILSON DANIEL SWAYZE, JR., 3804 CLEARWATER CT., PLANO, TX, 75025, US

(21) Appl. No.: 12/020,515

(22) Filed: Jan. 26, 2008

(51) Int. Cl. F21V 21/30

(52) U.S. Cl. 362/287

(57) ABSTRACT

A flexible floodlight assembly adapted to be used with a standard floodlight or light socket assembly may include a female socket member adapted to accept a floodlight bulb, a flexible intermediate section coupled to the female socket member, and a male socket member coupled to the flexible intermediate section. The flexible intermediate section may be deformable to direct floodlight to multiple positions. The flexible intermediate section may include a bellows housing member, and the flexible intermediate section may include an insulating member. The flexible intermediate section may include a wire member, and the configurable floodlight assembly may include a cover member to cover a portion of the floodlight bulb. The female socket member may include internal threads to cooperate with external threads of the floodlight bulb, and the male socket member may include external threads to cooperate with internal threads of the standard floodlight or light socket assembly.

### FIELD OF THE INVENTION

This invention relates generally to illumination and, more particularly, to a spotlight or floodlight which is adjustable in order to provide multiple configurations.

### BACKGROUND

Floodlights are available in two broad types, i.e., area and directional. As the name suggests, the former are used to illuminate large areas such as parking lots. Directional floodlights provide a smaller field of illumination and are popular with architects, lighting designers and building owners as a way to visually “highlight” certain building and landscape features and improve the nighttime appearance and ease of use of buildings and grounds.

Outdoor lighting has both utilitarian and aesthetic uses. For example, illumination of the areas around one's home, such as the yard, patio, walkway, or deck provides one with the safety and security associated with a well-lit area. Illumination also allows one to perform tasks around the home at night that otherwise could not be completed efficiently. In addition to its utilitarian aspect, outdoor lighting can have significant aesthetic uses as well. Modern lighting design is increasingly concerned with creating a balanced, comfortable and appealing environment, coordinated with the decorative and architectural scheme of the space to which the lighting is a part. Today, outdoor lighting has brought a more subtle enhancement to the illumination of homes, restaurants, museums, gardens, terminals, vehicles, sculptures, and virtually every kind of space used by people. Lighting is as much an art as it is a science.

There are many different types of outdoor lighting fixtures in use today. In the landscaping industry, decorative low voltage lighting fixtures are typically designed to fit securely in the ground. A stake having a pointed edge is usually connected at the end opposite the fixture. The fixture is then positioned by driving the pointed stake into the ground to a desired depth, leaving the fixture above the ground in its desired position. The fixture usually includes a light bulb positioned within a globe that both protects the light bulb and diffuses light emitted from the bulb. For example, a series of lighting fixtures may be lined up along the opposite sides of a sidewalk leading from the driveway to the front door of a residence. These fixtures typically contain lights of low-wattage and do not provide illumination of much intensity.

Floodlights are well-known and unlike typical landscaping fixtures, are commonly used to brightly illuminate large open areas. Floodlights typically are much brighter and therefore require fewer numbers than landscape lights to provide ample illumination. Floodlights have been traditionally designed for mounting at a height, such as to a wall or privacy fence, to light up a patio, a pool or yard, or for mounting to the floor or ceiling to act as “task-light” lighting for a garage, barn or loft or any other high-ceiling work area. Unlike landscape lighting fixtures, floodlights are not typically used for decorative lighting. However, some people have recognized the advantages associated with brightly illuminating large natural features such as trees and shrubs with floodlights. As a result, floodlights have recently been specifically designed for mounting near or in the ground, such as on grass or in a shrub bed, to act as a touch of nighttime landscaping artistry to highlight certain areas.

However, no floodlights are known that are capable of quick and easy inter-conversion between multiple configurations. Therefore, the general consumer is forced to purchase a number of lighting fixtures or floodlights in different configurations to meet different lighting objectives that may otherwise be met by one easily configurable floodlight assembly.

A new directional floodlight which better responds to the needs of architects, lighting designers and contractors and which provides certain manufacturing economies would be an important advance in the art.

U.S. Pat. No. 5,988,833 to Giese discloses that a floodlight has a housing and a housing support coupled to the housing. In the improvement, the support includes a strut extending along a strut axis and having a distal end and a pivot member at a proximal end. The pivot member is mounted for movement about an axis of rotation and has a boundary spaced from the axis of rotation by a first dimension. The housing includes a housing surface proximate the axis of rotation and spaced therefrom by a second dimension less than the first dimension. The housing includes a recess therealong and when the strut is folded against the housing, the strut is received in the recess. A group of floodlight components comprises a main housing and two or more differently-shaped center housings. The attachment portions of the center housings are sized and configured to be interchangeably received at the main housing forward opening. The group thereby accommodates any one of several different lamps, e.g., PAR 20, PAR 30 and/or PAR 38.

The present invention relates to a lighting fixture, in general, and more particularly, to a novel multi-configurable floodlight assembly which can be adapted for use in a number of different situations.

U.S. Pat. No. 5,655,828 to Lin discloses a multi-configurable floodlight assembly that may be configured to provide suitable lighting in a multitude of situations. The assembly includes a housing having top portion, side portion and bottom portion. The portions define a substantially hollow volume therebetween. Three threaded recesses are formed in the top portion of the housing, and at least one threaded recess is formed in the bottom portion. A plurality of knockouts are extend circumferentially around the side portion of the housing. Two light holders are provided each of which having a light socket for receiving a light bulb, a threaded base portion, and an universal joint disposed between the base portion and the light socket to provide for the movement of the light socket about the base portion. The threaded base portion is releasably insertable into any of the threaded recesses in the housing. To mount the floodlight assembly, a pair of flanges are provided secured to the housing that have an aperture therethrough to allow the receipt of a nail or screw. Alternatively, a mounting spike adapted to be secured to any of the threaded recesses or knockouts may be used.

Below are various patents which relate to flashlights.

A common type of portable light device, generally known as a “flashlight” is powered by one or more batteries. These devices generally have a light bulb portion at one end connected to an elongated handle portion for housing one or more batteries. Variations have been developed over the years in the general structure of the common portable flashlight device as described above.

One recent variation, sold under the trademark “The Snake” by Black & Decker Inc. of Newark, Del., provides a flexible flashlight having a light bulb at one end, a compartment for one or more batteries at the opposite end and an elongated flexibly deformable handle disposed therebetween having conductor means disposed therein for electrically connecting the light bulb portion with the battery compartment. The deformable handle which apparently employs a flexible assembly of connectors and can be wrapped around an object for retaining the flexible flashlight in a desired position.

U.S. Pat. No. 5,717,276 to Hsu discloses a flexible light includes a lens cap having a light bulb received therein, a bulb holder threadingly received the light bulb therein and threadingly engaging to the lens cap, a bellows having a first end which snugly engages with the bulb holder and a second end which snugly engages with a holding portion, wherein a flexible element is inserted within the bellows such that the flexible light is able to bend in great extent.

U.S. Pat. No. 7,175,295 to Bretz discloses a hands-free apparatus for illuminating an area surrounding a user's body includes a plurality of flexible tubes having mateable proximal end portions and spaced distal end portions positionable at a predetermined spatial relationship disposed forwardly of the proximal end portions. A power supply source is internally situated within the flexible tubes. A plurality of light-emitting sources are connected to the flexible tubes and electrically coupled to the power supply source respectively. The light-emitting sources each include a switch operably connected to the power supply sources such that a user may independently toggle each light-emitting sources between operating and non-operating modes. The switches are preferably connected to a plurality of housings encasing the light-emitting sources and are positioned distal to a maintaining mechanism medially attached to the flexible tubes.

### SUMMARY

A flexible floodlight assembly adapted to be used with a standard floodlight or light socket assembly may include a female socket member adapted to accept a floodlight bulb, a flexible intermediate section coupled to the female socket member, and a male socket member coupled to the flexible intermediate section. The flexible intermediate section may be deformable to direct light to multiple positions.

The flexible intermediate section may include a bellows housing member, and the flexible intermediate section may include an insulating member.

The flexible intermediate section may include a wire member, and the configurable floodlight assembly may include a cover member to cover a portion of the floodlight bulb.

The female socket member may include internal threads to cooperate with an external threads of the floodlight bulb, and the male socket member may include external threads to cooperate with internal threads of the standard floodlight or light socket assembly.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of a configurable floodlight assembly of the present invention;

FIG. 2 illustrates a perspective view of the configurable floodlight assembly of the present invention.

### DETAILED DESCRIPTION

It is a general object of the present invention to provide a floodlight or light socket assembly that is easily configurable such that a user may configure the Flexible Floodlight to meet a number of different lighting situations quickly and easily.

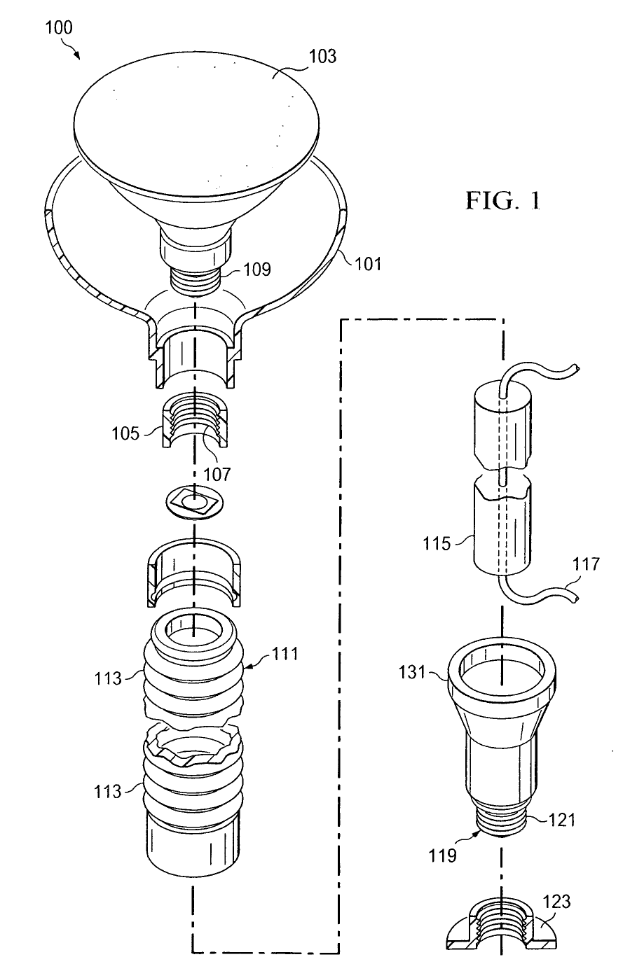

FIG. 1 illustrates an exploded view of the configurable floodlight assembly 100 of the present invention. The configurable floodlight assembly 100 includes a cover member 101 which is adapted to cooperate with and provide a cover for a portion of the floodlight bulb 103. The cover member 101 may be detachably connected to a female socket member 105 or may be integral with the female socket member 105 which may include internal threads 107 which cooperate with the external threads 109 of the floodlight bulb 103 to provide electrical connection to the floodlight bulb 103. FIG. 1 additionally illustrates a flexible intermediate section 111 which may be a variable length and which includes a bellows housing member 113, an insulating member 115 and a wire member 117. The bellows housing member 113 may be deformable to provide flexibility for the flexible intermediate section 111, and the insulating member 115 provides electrical insulation for the wire member 117 which may be a pair of wires for connection between the male socket member 119 and the female socket member 105 to provide electricity for the floodlight bulb 103. The bellows housing member 113 which may be formed from plastic or other suitable material, the insulating member 115 which may be formed from plastic or other suitable material and the wire member 117 may be detachably connected to the male socket member 119 or may be integral to the male socket member 119. The male socket member 119 includes external threads 121. FIG. 1 additionally illustrates a swivel device 131 to allow the male socket device 119 to rotate independently.

In order to provide greater flexibility, the configurable floodlight assembly 100 may be connected to a standard floodlight assembly or a standard light socket assembly by attaching the external threads 121 of the male socket member 119 to internal threads of a female socket member of the standard floodlight assembly or the standard light fixture assembly. In this manner, the flexible intermediate section 111 can be deformed in any position in order to allow the floodlight bulb 103 to shine in any direction side to side, front or back and up or down.

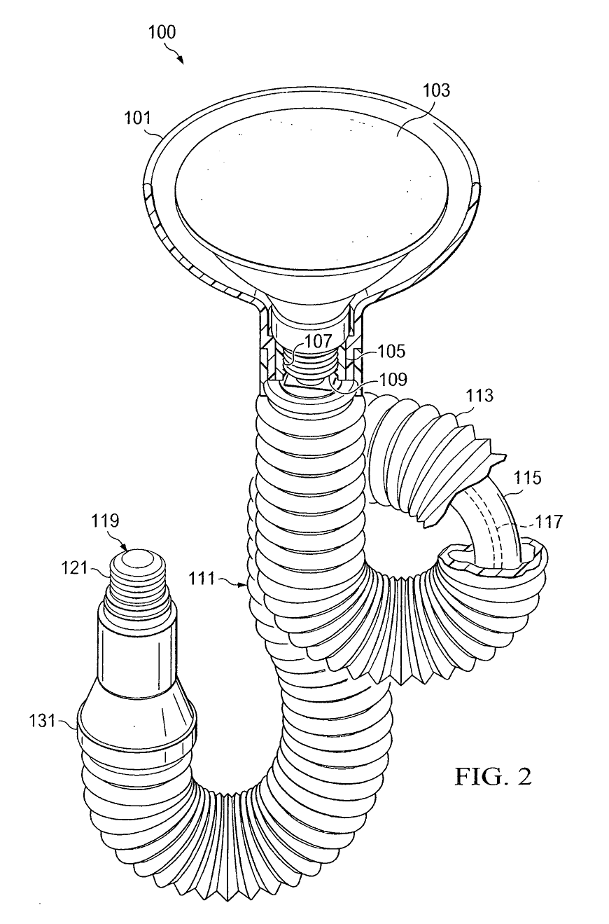

FIG. 2 illustrates that the flexible intermediate section 111 has been bent 180° and then the flexible intermediate section 111 has been turned on itself 360°.

FIG. 2 illustrates a perspective view of the configurable floodlight assembly 100 of the present invention. FIG. 2 shows that the configurable floodlight assembly 100 includes a cover member 101 which is adapted to cooperate with and provide a cover for a portion of the floodlight bulb 103. The cover member 101 may be detachably connected to a female socket member 105 or may be integral with the female socket member 105 which may include internal threads 107 which cooperate with the external threads 109 of the floodlight bulb 103 to provide electrical connection to the floodlight bulb 103. FIG. 2 additionally illustrates a flexible intermediate section 111 which includes a bellows housing member 113, an insulating member 115 and a wire member 117. The bellows housing member 113 may be deformable to provide flexibility for the flexible intermediate section 111, and the insulating member 115 provides electrical insulation for the wire member 117 which may be a pair of wires for connection between the male socket member 119 and the female socket member 105 to provide electricity for the floodlight bulb 103. The male socket member 119 includes external threads 121 to engage the standard floodlight assembly 123 or a standard light fixture assembly. FIG. 2 additionally illustrates a swivel device 131 to allow the male socket device 119 to rotate independently.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A flexible floodlight assembly adapted to be used with a standard floodlight or light socket assembly, comprising:
a female socket member adapted to accept a floodlight bulb;
a flexible intermediate section coupled to the female socket member;
a male socket member coupled to the flexible intermediate section;
wherein the flexible intermediate section is deformable to direct floodlight to multiple positions.

2. A flexible floodlight assembly adapted to be used with a standard floodlight or light socket assembly as in claim 1, wherein the flexible intermediate section includes a bellows housing member.

3. A flexible floodlight assembly adapted to be used with a standard floodlight or light socket assembly as in claim 1, wherein the flexible intermediate section includes an insulating member.

4. A flexible floodlight assembly adapted to be used with a standard floodlight or light socket assembly as in claim 1, wherein the flexible intermediate section includes a wire member.

5. A flexible floodlight assembly adapted to be used with a standard floodlight or light socket assembly as in claim 1, wherein the flexible floodlight assembly includes a cover member to cover a portion of the floodlight bulb.

6. A flexible floodlight assembly adapted to be used with a standard floodlight or light socket assembly as in claim 1, wherein the female socket member includes internal threads to cooperate with an external threads of the floodlight bulb.

7. A flexible floodlight assembly adapted to be used with a standard floodlight or light socket assembly as in claim 1, wherein the male socket member includes external threads to cooperate with internal threads of the standard floodlight or light socket assembly.

8. A flexible floodlight assembly adapted to be used with a standard floodlight or light socket assembly as in claim 1, wherein the standard assembly includes a standard floodlight or light socket assembly.

9. A flexible floodlight assembly adapted to be used with a standard floodlight or light socket assembly as in claim 1, wherein the standard assembly includes a standard light fixture assembly.
